(19) United States
(12) Patent Application Publication
(10) Pub. No.: US 2011/0089317 A1
(43) Pub. Date: Apr. 21, 2011

(54) Polarization Standards for Microscopy

(75) Inventors: Ignacy Gryczynski, Fort Worth, TX (US); Zygmunt Gryczynski, Forth Worth, TX (US); Rafal Luchowski, Fort Worth, TX (US); Julian Borejdo, Dallas, TX (US)

(73) Assignee: University of North Texas Health Science Center at Forth Worth, Fort Worth, TX (US)

(21) Appl. No.: 12/909,628

(22) Filed: Oct. 21, 2010

Related U.S. Application Data
(60) Provisional application No. 61/253,793, filed on Oct. 21, 2009.

(51) Int. Cl. G01D 18/00; G01N 31/00; C09K 11/06

(52) U.S. Cl. 250/252.1; 252/408.1; 252/301.35

(57) ABSTRACT

The present invention describes the development of thin film calibration strips for microscopy/spectroscopy systems and a simple method/routine to conduct instrument calibration using partially (uniaxially) oriented strip to calibrate microscopy system without the prior knowledge of exact polarization of the strip. The invention describes results from studies including a styryl derivative (LDS 798) embedded in poly(vinyl alcohol) (PVA) film. These films were progressively stretched up to 8 folds. Vertical and horizontal components of absorptions and fluorescence were measured and dichroic ratios were determined for different film stretching ratios. The stretched films have high polarization values for isotropic excitation. The isotropic and stretched PVA films doped with LDS 798 can be used as etalons in near infra red (NIR) spectroscopic measurements. The high polarization standards of the present invention have applications in NIR imaging microscopy where they can be used for correcting for instrumental factor in polarization measurements.

### CROSS-REFERENCE TO RELATED APPLICATIONS

This Non-Provisional Patent Application claims priority to U.S. Provisional Patent Application Ser. No. 61/253,793, filed on Oct. 21, 2009, the contents of which are all incorporated by reference herein in their entirety.

### TECHNICAL FIELD OF THE INVENTION

The present invention relates in general to the field of fluorescence polarization (anisotropy) measurements, and more particularly to the development of thin film calibration strips for microscopy/spectroscopy systems and a method for the use of such strips for routine calibration of microscopy systems.

### STATEMENT OF FEDERALLY FUNDED RESEARCH

None.

### INCORPORATION-BY-REFERENCE OF MATERIALS FILED ON COMPACT DISC

None.

### BACKGROUND OF THE INVENTION

Without limiting the scope of the invention, its background is described in connection with calibration standards and methods for calibrating microscopy/spectroscopy systems.

U.S. Pat. No. 6,259,524 issued to Hofstraat et al. (2001) teaches a calibration layer comprising an optically transparent polymer containing an amount of photobleachable luminscent material present in such a way that the final polymer film contains less than 10 wt. % of luminophore and has an optical attenuation of less than 0.3 absorption units in the wavelength region of interest. The invention further is concerned with a method of calibration of an optical image device, preferably an optical or Raman microscope, by using the decrease in luminescence as the result of photobleaching between two consecutive images for calibration.

U.S. Pat. No. 7,072,036 issued to Jones et al. (2006) discloses a multi-modality fluorescence reference plate comprising wells coated with a fluorogenic compound, together with a method of producing such a plate. The plate has utility for calibrating fluorescent plate readers and imaging systems for measuring steady-state fluorescence, time-resolved fluorescence, fluorescence lifetime and/or fluorescence polarization.

U.S. Pat. No. 7,248,356 issued to Pfeiffer (2007) describes a calibration aid assembled by preparing a standard reference substance by dissolving ICG dye and albumin protein in water. A carrier sheet of fleece material is soaked therein and dried. After drying the carrier sheet, a thin well defined layer of protein bound dye is present at the surface of the fleece material. The carrier sheet and a backing sheet are laminated into a plastic card. For this, the plastic layers may be laminated tightly together in the framing region, for example by welding or by use of adhesive. The calibration aid comprising the plastic card is then sterilized and packed into a sealed package.

### SUMMARY OF THE INVENTION

The present invention is directed towards the development of thin film calibration strips for microscopy/spectroscopy systems. The invention further describes the development of a simple method/routine to conduct instrument calibration using a partially (uniaxially) oriented strip to calibrate a microscopy/spectroscopy system without the prior knowledge of the exact polarization of the strip.

In one embodiment the present invention is a microscopy/spectroscopy system calibration standard comprising a polymer film, stretched polymer film or a liquid crystal embedded with one or more dyes, wherein the calibration standard comprises a consistent polarization value and stability. In one aspect of the present invention, the dye used is selected from 7-Amino-actinomycin D, Acridine orange; Acridine yellow; Alexa Fluor; AnaSpec; Auramine O; Auramine-rhodamine stain; Benzanthrone; 9,10-Bis(phenylethynyl)anthracene; 5,12-Bis(phenylethynyl)naphthacene; CFDA-SE; CFSE; Calcein; Carboxyfluorescein; 1-Chloro-9,10-bis(phenylethynyl)anthracene; 2-Chloro-9,10-bis(phenylethynyl)anthracene; Coumarin; Cyanine; DAPI; Dark quencher; Dioc6; DyLight Fluor; Ethidium bromide; Fluorescein; Fura-2; Fura-2-acetoxymethyl ester; Green fluorescent protein; Hilyte Fluor; Hoechst stain; Indian yellow; Luciferin; Perylene; Phycobilin; Phycoerythrin; Phycoerythrobilin; Propidium iodide; Pyranine; Rhodamine; RiboGreen; Rubrene; Ruthenium(II) tris(bathophenanthroline disulfonate); diphenyl polyenes; stilbenes; trans-styrenes; p-terphenyl derivatives; styryl 11, SYBR Green; Stilbene; TSQ; Texas Red; Umbelliferone and Yellow fluorescent protein.

In another aspect the polymer is partially (axially) oriented and is selected from polyolefins, polyesters, polyamides, polyurethanes, Poly(vinyl) alcohol, Poly(allylamine), polyethylene, polypropylene, fluoropolymers, PVF, PVDF, PFA, FEP, co-polymers, Acrylic acid, Acrylamide, (Diethylamino)ethyl methacrylate, (Ethylamino)methacrylate, Methacrylic acid, methylmethacrylate, Triazacyclononane-copper(II) complex, 2-(methacryloyxloxy) ethyl phosphate, methacrylamide, 2-(trifluoromethyl)acrylic acid, 3-aminophenylboronic acid, poly(allylamine), o-phthalic dialdehyde, oleyl phenyl hydrogen phosphate, 4-vinylpyridine, vinylimidazole, 2-acryloilamido-2,2′-methopropane sulfonic acid, Silica, organic silanes, N-(4-vinyl)-benzyl iminodiacetic acid, Ni(II)-nitrilotriacetic acid, N-acryloyl-alanine, ethylene glycol dimethacrylate, pentaerythritol triacrylate, pentaerythritol tetraacrylate, trimethylolpropane trimethacrylate, vinyl triethoxysilane, vinyl trimethoxysilane, toluene 2,4-diisocyanate, epichlorohydrin, triglycerolate diacrylate, polystyrene, Propylene glycol dimethacrylate, poly(ethylene glycol)n dimethacrylate, methacrylate derived silica, acrylonitrile, N,N′-dimethylacrylamide, and poly(ethylene glycol)diacrylate.

In yet another aspect the dyes have an absorption and an emission spectra in an optical UV, a visible, or a NIR range. In various aspects of the present invention the dyes have an absorption and an emission spectra between about 210 nm and about 900 nm. The dyes have an absorption and an emission spectra of 200 nm, 210 nm, 250 nm, 300 nm, 350 nm, 400 nm, 450 nm, 500 nm, 550 nm, 600 nm, 630 nm, 635 nm, 650 nm, 700 nm, 730 nm, 750 nm, 800 nm, 850 nm, and 900 nm. In one aspect the polymer is stretched between about 1 to about 10 times the polymer length. The polymer is stretched 1, 2, 3, 4, 5, 6, 7, 8, 9, and 10 times the polymer length. In another aspect the polymer has a thickness between about 5 and about 5000 micrometers. The polymer has a thickness of 5, 50, 100, 250, 500, 750, 1000, 2000, 2500, 3000, 4000, and 5000 micrometers.

In specific aspects of the present invention the calibration standard is used as a standard in a fluorescence polarization technique for the detection of a nonmelanoma skin cancers, diagnosis of a colon cancer, assessment of a fetal lung maturity, and a high throughput screening assays/drug development. The stretched polymer film further comprises a plastic or laminate on or about it.

In another embodiment the present invention describes a method of preparing a calibration standard comprising the steps of: (i) embedding a dye by mixing the stretchable polymer solution with a solution of a dye to form a dye-embedded polymer solution, (ii) drying the dye-embedded polymer solution to form a dye-embedded polymer film, (iii) stretching the dye-embedded polymer film to obtain the stretched dye-embedded polymer film, and (iv) measuring an absorption, emission, and excitation spectra of the stretched dye-embedded polymer film, wherein the stretched dye-embedded polymer film provides a known dichroic ratio, a fluorescence quantum yield, a lifetime and an anisotropy.

The step of embedding the dye in the stretchable polymer can be alternatively accomplished by any one of the following three methods: (i) crushing the dye and mixing it with the one or more stretchable polymer flakes to form a mixture, a blend or a mold followed by extruding the mixture, the blend or the mold, (ii) mixing or dissolving the dye in a polymer melt and allowing the mixture or solution to cool to form a film or (iii) by mixing or dissolving the dye and polymer in a solvent and then removing the solvent.

In one aspect of the method of the present invention the a fluorescence signal, a polarization signal or both of the dye in the stretched dye-embedded polymer film is measured in a square or a front-face configuration, an in-line configuration, a combination of one or all the configurations.

The dyes are selected from 7-Amino-actinomycin D, Acridine orange; Acridine yellow; Alexa Fluor; AnaSpec; Auramine O; Auramine-rhodamine stain; Benzanthrone; 9,10-Bis(phenylethynyl)anthracene; 5,12-Bis(phenylethynyl)naphthacene; CFDA-SE; CFSE; Calcein; Carboxyfluorescein; 1-Chloro-9,10-bis(phenylethynyl)anthracene; 2-Chloro-9,10-bis(phenylethynyl)anthracene; Coumarin; Cyanine; DAPI; Dark quencher; Dioc6; DyLight Fluor; Ethidium bromide; Fluorescein; Fura-2; Fura-2-acetoxymethyl ester; Green fluorescent protein; Hilyte Fluor; Hoechst stain; Indian yellow; Luciferin; Perylene; Phycobilin; Phycoerythrin; Phycoerythrobilin; Propidium iodide; Pyranine; Rhodamine; RiboGreen; Rubrene; Ruthenium(II) tris(bathophenanthroline disulfonate); diphenyl polyenes; stilbenes; trans-styrenes; p-terphenyl derivatives styryl 11, SYBR Green; Stilbene; TSQ; Texas Red; Umbelliferone and Yellow fluorescent protein.

In another aspect the polymer is selected from polyolefins, polyesters, polyamides, polyurethanes, Poly(vinyl) alcohol, Poly(allylamine), polyethylene, polypropylene, fluoropolymers, PVF, PVDF, PFA, FEP, co-polymers, Acrylic acid, Acrylamide, (Diethylamino)ethyl methacrylate, (Ethylamino)methacrylate, Methacrylic acid, methylmethacrylate, Triazacyclononane-copper(II) complex, 2-(methacryloyxloxy) ethyl phosphate, methacrylamide, 2-(trifluoromethyl)acrylic acid, 3-aminophenylboronic acid, poly(allylamine), o-phthalic dialdehyde, oleyl phenyl hydrogen phosphate, 4-vinylpyridine, vinylimidazole, 2-acryloilamido-2,2′-methopropane sulfonic acid, Silica, organic silanes, N-(4-vinyl)-benzyl iminodiacetic acid, Ni(II)-nitrilotriacetic acid, N-acryloyl-alanine, ethylene glycol dimethacrylate, pentaerythritol triacrylate, pentaerythritol tetraacrylate, trimethylolpropane trimethacrylate, vinyl triethoxysilane, vinyl trimethoxysilane, toluene 2,4-diisocyanate, epichlorohydrin, triglycerolate diacrylate, polystyrene, Propylene glycol dimethacrylate, poly(ethylene glycol)n dimethacrylate, methacrylate derived silica, acrylonitrile, N,N′-dimethylacrylamide, and poly(ethylene glycol) diacrylate. In yet another aspect the dyes have an absorption and an emission spectra in an optical UV, a visible, or a NIR range. In various aspects of the present invention the dyes have an absorption and an emission spectra between about 210 nm and about 900 nm. The dyes have an absorption and an emission spectra of 200 nm, 210 nm, 250 nm, 300 nm, 350 nm, 400 nm, 450 nm, 500 nm, 550 nm, 600 nm, 630 nm, 635 nm, 650 nm, 700 nm, 730 nm, 750 nm, 800 nm, 850 nm, and 900 nm.

The polymer is stretched between about 1 to about 10 times the polymer length. The polymer is stretched 1, 2, 3, 4, 5, 6, 7, 8, 9, and 10 times the polymer length. In another aspect the polymer has a thickness between about 5 and about 5000 micrometers. The polymer has a thickness of 5, 50, 100, 250, 500, 750, 1000, 2000, 2500, 3000, 4000, and 5000 micrometers. The stretched polymer film further comprises a plastic or laminate on or about it and the polymer film is partially (axially) oriented.

In yet another embodiment the present invention discloses a method of calibrating a microscopy system or a spectroscopy system comprising the steps of: (i) placing a calibration standard comprising a stretched polymer film embedded with a flurophore-containing dye in or on the microscopy or the spectroscopy system, wherein the dye has an absorption and an emission spectra in an optical UV, a visible, or a NIR range, (ii) stretching the polymer film in a direction parallel or perpendicular to the direction of a polarized light emanating from a polarizer of the microscopy or the spectroscopy system, (iii) illuminating the stretched polymer film with a visible non-polarized light, (iv) observing the light from an analyzer of the microscopy or the spectroscopy system, wherein the analyzer is oriented in a direction that is different from the direction of the stretched polymer film, and (v) calibrating the microscopy or spectroscopy system by the measuring and quantifying one or more parameters selected from dichroic ratio, fluorescence quantum yield, lifetime, and anisotropy. In a related aspect the method discloses the step of calculating a G factor. In specific aspects the stretched polymer film is a PVA film, the dye is a styryl derivative and the polarization of the calibration standard is known a priori.

In one embodiment the present invention describes a method of calibrating a microscopy system or a spectroscopy system by a determination of a G-factor value using a calibration standard, wherein an anisotropy of the calibration standard is not known a priori, comprising the steps of: placing the calibration standard, comprising a stretched polymer film embedded with a flurophore-containing dye, in or on the microscopy or the spectroscopy system, wherein the dye has an absorption and an emission spectra in an optical UV, a visible, or a NIR range, stretching the polymer film first in a parallel orientation followed by stretching the polymer film in a perpendicular orientation, wherein these orientations are performed relative to the direction of a polarized light emanating from a polarizer of the microscopy or the spectroscopy system, exciting the stretched polymer film by illumination with a visible non-polarized light at a 45° angle, observing the light from an analyzer of the microscopy or the spectroscopy system, wherein the analyzer is oriented in a direction that is different from the direction of the stretched polymer film, measuring a light intensity through the film at the parallel orientation and the perpendicular orientation, and determining a ratio of the intensities of measured with both the parallel and perpendicular orientations, wherein the ratio is equal to the G factor value. In one aspect the polarization of the calibration standard is not known a priori. In another aspect the stretched polymer film is a PVA film and the dye is a styryl derivative.

### BRIEF DESCRIPTION OF THE DRAWINGS

For a more complete understanding of the features and advantages of the present invention, reference is now made to the detailed description of the invention along with the accompanying figures and in which:

FIG. 1A shows the geometry of photoselection. P—polarization filter, A_{II} and A₁₉₅—absorbances of light measured parallel and perpendicular to stretching direction, ω₁, ω—angles between orientation (stretched) axis (z) and transition dipole moments for absorption (\vec{A}) and long axis of molecule (OM) respectively, φ—angle between transition dipole moment, \vec{A} molecular axis OM, δ is the angle formed by the planes (z,OM) and (z, \vec{A});

FIG. 1B shows the geometry of dichroic calculations. \vec{ε}—polarized electric vector of excitation light, P—projection of the polarization filter, I_{II} and I₁₉₅—intensities of emission light measured parallel and perpendicular to the incidence polarization. ω₁, ω₂—angles between photoselection axis (z) and transition dipole moments for absorption (\vec{A}) and emission (\vec{E}) respectively, 62—angle between transition dipole moments \vec{A} and \vec{E}, δ—angle formed by the planes (z, \vec{A}) and (\vec{E}, \vec{A});

FIG. 2 shows the chemical structure of NIR fluorophore LDS 798;

FIG. 3 shows the normalized absorption and emission spectra LDS 798 in isotropic (unstretched) PVA film, shown as a solid and a dotted line, respectively. Filled and empty points present anisotropy data for excitation (observed at 750 nm) and emission (excitation at 635 nm) fluorescence, respectively;

FIG. 4 shows parallel (-) and perpendicular (- -) polarized absorption spectra of LDS 798 recorded for different values of stretching ratio RS;

FIG. 5 shows the dependence of dichroic ratio R_{d} on stretching ratio R_{S} for LDS 798-doped PVA films. Symbols correspond to experimental data and the continuous line corresponds to the theoretical values obtained for φ=0° in Eq. (15). The error bars for R_{S} were estimated with the assumption of 0.2 mm accuracy in the length measurements;

FIG. 6 shows the experimental points and theoretical prediction for the dependence of the absorption anisotropy K(R_{S}, φ) on the stretching ratio R_{S} for LDS 798-doped PVA films. The theoretical line was calculated from Eq. (13) with the assumption φ=0°

FIG. 7A is a photograph of stretched LDS 798-doped PVA film;

FIG. 7B shows the intensities of fluorescence emission observed for four different angles (0, 45, 70, and 90°) relative to the stretching direction of the PVA film;

FIG. 8 shows the images observed for highly stretched PVA film with LDS 798 for two different polarizations: (8A) perpendicular and (8B) parallel;

FIG. 9 shows the dependence of the emission anisotropy r (and polarization P) on the dichroic ratio R_{d} determined for stretched PVA films doped with LDS 798. FIG. 9 presents experimental data (points) and the least square fit to them by using Eq. (14);

FIG. 10 shows the fluorescence intensity decay of LDS 798-doped PVA film (isotropic). Excitation was 635 mm, observation was 750 mm;

FIG. 11 shows the fluorescence intensities of polarized components observed for an isotropic sample of LDS 798-doped PVA film. The sample was rotated on the microscope stage and illuminated by high numerical aperture objective 1.2, 60× OLYMPUS. To obtain a correct value of anisotropy (0.32, FIG. 3), the parallel component must be multiplied by a G factor of 1.16;

FIG. 12A shows the fluorescence intensity of a parallel component observed for the 8-fold stretched sample of LDS 798-doped PVA film; and

FIG. 12B shows the perpendicular component of this sample. The sample was rotated on the microscope stage.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

There present invention comprises two parts: I. Development of thin film calibration strips for microscopy/spectroscopy systems and II. Development of a simple method/routine to conduct instrument calibration using a partially (uniaxially) oriented strip to calibrate a microscopy or spectroscopy system without prior knowledge of exact polarization of the strip.

The present inventors realized that an oriented system or partially oriented system (such as a stretched polymer film, liquid crystal, etc.) can be conveniently used as high polarization standards for microscopy or spectroscopy. Such polymer films are typically very thin (between about 5-1000 microns) and are very stable (both in physicochemical and optical properties). So, they can be used as a standard to calibrate a typical confocal microscopy system. Typically the calibration procedure involves the determination of the G-factor. This is done by using a standard having known polarization. An oriented system (such as a stretched polymer with embedded dye molecules) could be a very convenient standard with high polarization. One may easily produce such film strips and use them for calibration. Such polymers can be additionally embedded in any protective material such as plastic or a laminate to preserve its function. Polarization of such polymer elements can be measured on independent instrumentation. Such protective materials will serve to preserve the fluorescence polarization of embedded molecules for an extended period of time, such that the stretched polymer can be conveniently used as a standard to calibrate fluorometers and microscope systems.

The ongoing problem of any high polarization standard is its long term stability. Many standards may change/vary polarization over time, or according to temperature or other physical factors. In fact, variation of the calibrated value of a standard as a function of physical factors or preparation has to date represented an insurmountable challenge in the development of a viable high polarization standard. The present invention provides a unique advantage in that the use of uniaxially oriented samples (such as the stretched polymer described herein) appears to provide a new method for calibration that is independent of actual polarization value. In other words, imprecision in the initial calibration of a polarization value, or a polarization change over time or due to physical factors, will not effect the outcome of instrument calibration. In the present invention microscopy/spectroscopy calibration can be successfully performed without prior knowledge of sample polarization when a partially oriented film is used. A simple routine has been established and is disclosed herein to perform calibration with a partially (axially) orientated film, when the absolute value of film polarization is not necessary known.

Fluorescence polarization (anisotropy) measurements have long been of value in studying macromolecular mobility in vitro using proteins or other biomolecule solutions in a cuvette-based system. Presently, more sophisticated applications of fluorescence anisotropy using a microscope configuration provide unique opportunities for characterization and tracking of small subunits of living systems and monitoring biological processes in vivo. Small volumes of sample necessary for confocal detection make it possible to perform anisotropy measurements even inside cells. This creates many new applications for fluorescence polarization such as the characterization of microviscosity of cell interiors. Similarly, confocal volume localized FRET measurements provide information about distance distribution and FRET between GFPs expressed in bacteria and cells. The sophisticated optics of a typical microscopy system contains multiple optically active elements and proper interpretation of the details of these measurements will require very precise optical system calibration. Typically the calibration of cuvette based systems is well standardized and easy to perform, but is much more complicated for microscopy measurements. The calibration of microscopy systems calls for special geometrical conditions and, most importantly, for fluorescent standards to correct for light depolarization by the massive number of optical elements present in a microscope's optical path.

Over the years many fluorescence standards/calibration methods for polarization measurements in classic fluorometric configurations (square and front-face) have been developed and are widely used to calibrate optical pathways in standard fluorometers, to determine the G factor correction). Typically optical paths in microscopes are much more complex then those in fluorometers, and contains multiple optical elements. Advanced elements such as high numerical aperture (NA) objectives may drastically effect the polarization of transmitted light. Until the present invention, there has been no simple standard/calibration methods that can be used to accurately test and calibrate an optical path for a microscopy system. Genger et al. (2005) [19 discussed the need for and requirements of fluorescence standards for the accurate characterization and performance validation of fluorescence instruments, to enhance the comparability of fluorescence data, and to enable quantitative fluorescence analysis. Genger et al. (2008) [2] derived general and scope-specific requirements and quality criteria for suitable devices and materials and briefly addresses metrological requirements linked to the realization of comparable measurements with special emphasis dedicated to liquid and solid chromophore-based fluorescence standards.

The present invention addresses the lack of a high polarization standard for microscopy systems; it also serves to provide a standard for use with spectroscopy. The present invention provides polymer film of known polarization which can be conveniently used to perform routine/daily calibrations of microscopy systems. The use of the oriented films of the present invention without prior knowledge of a film's polarization is beneficial since polarization variation of the standard will not compromise G factor determination. The preparation of polymer films of various thicknesses (from microns to millimeters), as provided in the present invention, is applicable to virtually any experimental conditions. Protection of the polymer film by any transparent polymer such as plastic or a laminate material could serve to extend its function for a prolonged period of time.

Fluorescence spectroscopy is a well recognized tool for probing molecular structures, environment, and studying underlying dynamics of biomolecular systems in-vitro and in-vivo. Rapidly growing applications of fluorescence in cellular and tissue imaging stimulated great efforts to develop new water-soluble fluorophores that emit in red and near infra-red (NIR) spectral range where the background (autofluorescence) from biological samples is minimized. Many of biological processes like biomolecular transport, ligand binding, protein-protein interactions can be now monitored on cellular and tissue level. During the last decade progress in detector technology also enabled new advanced applications of fluorescence microscopy that now extend to detection and studying even single molecule systems. The biggest obstacles for single molecule studies are background fluorescence, fluorophore photostability and fluorophore blinking Today's market offers wide variety of red and NIR fluorescence labels as well as fluorescence proteins that can be used for labeling biological systems. An ideal fluorescent dyes for single molecule spectroscopy should have high photostability, high quantum yield and minimal blinking

Many of new emerging applications also begin to use more sophisticated fluorescence measurements in microscopy setup. Fluorescence lifetime imaging (FLIM) [3] and/or Förster resonance energy transfer (FRET) [4-6] are frequently used to directly study proteins interaction and co-localization [7-8]. Also measurements of fluorescence polarization and fluorescence correlation spectroscopy (FCS), that yields macromolecular mobility and flexibility on cellular level, become more common [9-11]. It becomes more and more evident that many of these new applications will benefit from information on basic spectroscopic properties of fluorescent probes. Generally available information is limited to extinction coefficient, quantum yield, and occasionally fluorescence lifetime. The fundamental information regarding number of available transitions or orientation of transition moments is almost always not available or unknown for new dyes. This information can be crucial for orientational factor determination and FRET data interpretation [12-13]. Also, knowledge of transition moment orientation may generally help in rational use of the dye as a label to study polarization and mobility of biological systems.

Fluorescence polarization (anisotropy) measurements have long proved its value to study macromolecular mobility in-vitro using protein or other biomolecule solution in the cuvette system. These measurements usually require very precise optical system calibration using special geometrical condition or molecular standards to correct for light depolarization by many instrumental factors. Over the years many fluorescence standards for polarization measurements in the classic fluorometric configuration (square and front-face) have been developed [14-17]. Such standards are typically used to calibrate optical pathways in standard fluorometers (so call G-factor correction). However, more and more biological studies based on fluorescence polarization reach now to sub-cellular level and are routinely used in microscopy. Typical microscope configuration is very different from fluorometers and contains multiple optical elements, especially high numerical aperture (NA) objectives that may drastically effect polarization of transmitted light. Unfortunately to date there are no useful standards that could be used to test and calibrate optical path for microscope system.

Laser dyes dispersed in polymers either poly(vinyl alcohol) (PVA) or poly(vinylpyrrolidone) (PVP) solid matrices have been previously described in the literature. The PVA matrix is more compatible with water-soluble dyes and the films detach easily from the supporting glass substrate. The PVP films are more compatible with dyes soluble in organic solvents and form extremely tenacious films which can only be removed by dissolution [18]. Pfeiffer et al. [19] developed a simple tool for the characterization of the relative spectral responsivity and the long-term stability of the emission channel of fluorescence instruments under routine measurement conditions thereby providing the basis for an improved comparability of fluorescence measurements and eventually standardization.

In the present invention the inventors use a commercially available fluorescent dye, LDS 798 (styryl 11), that has a very wide visible absorption band from about 450 to 730 nm with a maximum absorption peak at about 600 nm and maximum emission at 750 nm. These are very convenient wavelengths for laser diode excitations at 635 nm and 650 nm, which are generally available with today's microscopy systems. Excitation and emission polarizations, fluorescence lifetimes, and transition moment orientation for this dye have been determined. Linear dichroism (LD) and fluorescence polarization studies in oriented polymer films revealed that low energy absorption transition dipoles and emission transition dipoles are oriented along a long molecular axis. Stretched polymer films with embedded dyes can be conveniently used as high polarization standards for microscopy and spectroscopy. Such polymer films are very thin, ranging to below 100 microns, and are very stable. The disclosure presents simple examples how to use such standard to test and calibrate typical confocal microscopy system.

Materials and Methods.

Chemicals: All studies described below were performed using LDS 798 and PVA obtained as powder from Exciton (OH) and Sigma Aldrich, respectively and used without further purification. All aqueous solutions were prepared from deionized water (Millipore). 10% PVA films were prepared by dissolving PVA in water heated to 100° C. under stirring for 2-3 hours. The mixtures LDS 798 with PVA were poured onto horizontal glass plates and left for 48 hours to dry.

The films were removed, clamped in a stretching device, and progressively stretched to ˜8 times their original length.

Instrumentation: Absorption, emission and excitation spectra were recorded using Cary 50 Bio and Cary Eclipse fluorescence spectrophotometers (Varian, Inc.) respectively supplemented with manual rotatable polarizers in the light path. Polarized components of the fluorescence emission were measured in a front-face configuration on FluoTime 200 (Picoquant GmbH) equipped with 635 nm laser diode which was near the absorption maximum of LDS 798. The fluorescence passed through a long wavelength pass (LWP650) filter, Glan-Taylor (G-T) polarizer and monochromator. The emission intensities measured alternatively for parallel and perpendicular orientation of polarizer-analyzer.

The theory for polarized absorption and emission of prolate dyes oriented in stretched PVA films has been previously described in details [17, 20-24]. Two orthogonal absorption components (A_{∥}(λ) and A_{⊥}(λ)) measured for light polarized in two orthogonal directions, parallel (II) and perpendicular (⊥) to the stretching direction, can be expressed by the dichroic ratio R_{d} in the following form:

$${R}_{d} ( λ ) = \frac{{A}_{II} ( λ )}{{A}_{⊥} ( λ )} \qquad ( 1 )$$

The measured value of dichroic ratio, R_{d} dependents on stretching ratio R_{S}=a/b (defined as the axial semi-major a and b—mainor axis of an ellipse deformed from a circle of radius which was initially drawn on the film [21]). And the absorption anisotropy K [25-26] is given by:

$$K ( λ ) = \frac{{A}_{II} ( λ ) - {A}_{⊥} ( λ )}{{A}_{II} ( λ ) + 2 {A}_{⊥} ( λ )} = \frac{{R}_{d} ( λ ) - 1}{{R}_{d} ( λ ) + 2} \qquad ( 2 )$$

The measured wavelength dependent emission anisotropy r(λ) is defined as:

$$r ( λ ) = \frac{{I}_{VV} ( λ ) - G ( λ ) {I}_{VH} ( λ )}{{I}_{VV} ( λ ) + 2 G ( λ ) {I}_{VH} ( λ )} \qquad ( 3 )$$

where, G(λ) is the wavelength dependent instrumental correction factor (G-factor). The first index refers to the orientation of excitation polarizer (H—horizontal, V—vertical) and the second to the orientation of emission polarizer.

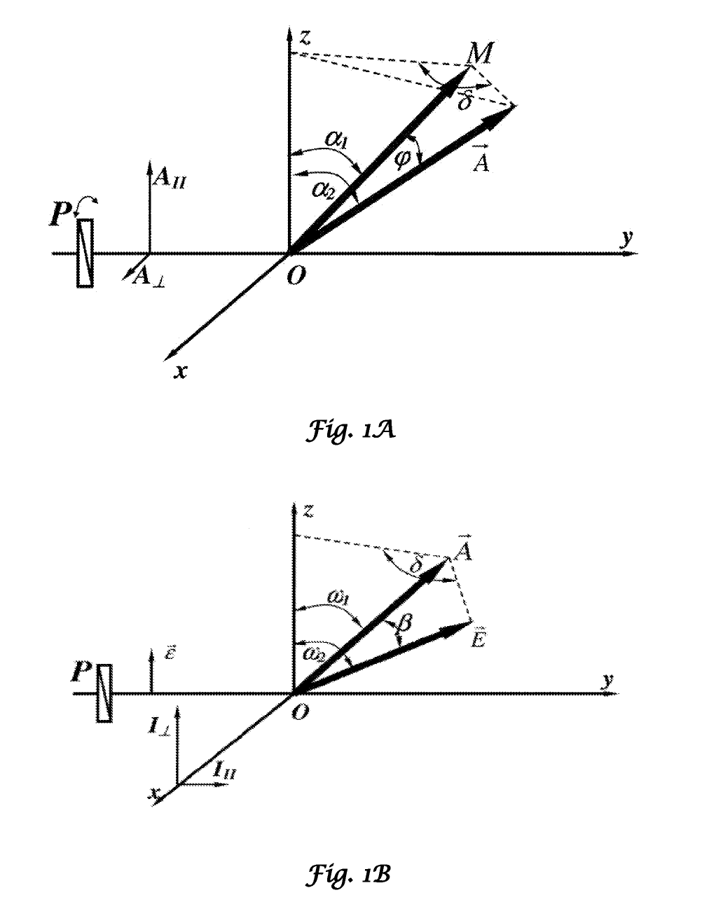

The limiting value of the anisotropy (polarization) for a single electronic transition is reached when no molecular reorientation occurs during the excited state lifetime. Calculation of theoretical values of absorption and emission anisotropy relays on assumption that a rigid isotropic solution of fluorophores is excited by linearly polarized light and photoselected molecules conserve the initial distribution. FIG. 1 represents arbitrary selected molecule in the coordinate system.

Angles ω₁ refers to the orientation of the absorption transition moment and ω₂ to the orientation of the emission transition moment of the molecule respectively. φ is the angle between long axis (OM) of the molecule and the absorption transition dipole moment (\vec{A}) and β is the angle between absorption and emission (\vec{E}) transition moments. Value of absorption (K(ω,φ)) and emission anisotropy (r(ω₁,β)) can be expressed [22]:

$$\begin{matrix}K ( ω , ϕ ) = \frac{3 〈 {cos}^{2} {ω}_{1} 〉 - 1}{2} = ( \frac{3}{2} 〈 {cos}^{2} ω 〉 - \frac{1}{2} ) ( \frac{3}{2} {cos}^{2} ϕ - \frac{1}{2} ) & ( 4 ) \\ r ( {ω}_{1} , β ) = \frac{3 〈 {cos}^{2} {ω}_{2} 〉 - 1}{2} = ( \frac{3}{2} 〈 {cos}^{2} {ω}_{1} 〉 - \frac{1}{2} ) ( \frac{3}{2} {cos}^{2} β - \frac{1}{2} ) & ( 5 )\end{matrix}$$

where, ω and ω₁ are angles between z—axis of coordinate system and long axis of molecule (ω) and absorption transition dipole moment \vec{A} respectively. β is the angle between absorption and emission transition dipole moments and ω₂ is the angle between z—axis and emission transition moment. For the uniform distribution around the δ angle the average value of cos² ω or cos² ω₁ is given by:

$$\begin{matrix}〈 {cos}^{2} ω 〉 = \frac{{\int }_{0}^{π / 2} f ( ω ) {cos}^{2} ω d ω}{{\int }_{0}^{π / 2} f ( ω ) d ω} & ( 6 ) \\ 〈 {cos}^{2} {ω}_{1} 〉 = \frac{{\int }_{0}^{π / 2} f ( {ω}_{1} ) {cos}^{2} {ω}_{1} d {ω}_{1}}{{\int }_{0}^{π / 2} f ( {ω}_{1} ) d {ω}_{1}} & ( 7 )\end{matrix}$$

where, function ƒ(ω)dω and ƒ(ω₁)dω₁ describe the distribution of long molecular axis (OM) and distribution of absorption dipole moment respectively. The orientational distribution function for elongated molecules in stretched polymer can be described as a function of stretching ratio, Rs [27]:

ƒ(ω)=R_{S}² sin ω[1+(R_{S}²−1)sin ² ω]^{-3/2} cos ω (8)

Considering Eq. 8 one may calculate both anisotropies (K and r) dependent on stretching ratio and angle φ, between long axis of molecule and transition dipole moment for absorption (or angle between absorption and emission transition dipole moments) β for r calculation):

$$\begin{matrix}K ( ϕ , {R}_{S} ) = \{ \frac{3}{2} {a}^{2} [ 1 - {( {a}^{2} - 1 )}^{0.5} arcsin ( 1 / a ) ] - \frac{1}{2} \} ( \frac{3}{2} {cos}^{2} ϕ - \frac{1}{2} ) & ( 9 ) \\ r ( β , {R}_{d} ) = [ \frac{9}{8} \frac{1 + {a}^{2} ( {a}^{2} - 2 ) + 0.5 {{a}^{2} ( {a}^{2} - 1 )}^{0.5} ( 2 - 1.5 {a}^{2} ) arcsin ( 1 / a )}{1 - {a}^{2} + {{a}^{2} ( {a}^{2} - 1 )}^{0.5} arcsin ( 1 / a )} ] ( 1.5 {cos}^{2} β - 0.5 ) \\ where a = \frac{{R}_{S}^{2}}{{R}_{S}^{2} - 1} & ( 10 )\end{matrix}$$

and R_{d} is given by:

$${R}_{d} = 2 \frac{1 + {a}^{2} [ 1 - {( {a}^{2} - 1 )}^{0.5} arcsin ( 1 / a ) ] ( 3 {cos}^{2} ϕ - 1 ) - {cos}^{2} ϕ}{1 - {a}^{2} [ 1 - {( {a}^{2} - 1 )}^{0.5} arcsin ( 1 / a ) ] ( 3 {cos}^{2} ϕ - 1 ) + {cos}^{2} ϕ} \qquad ( 11 )$$

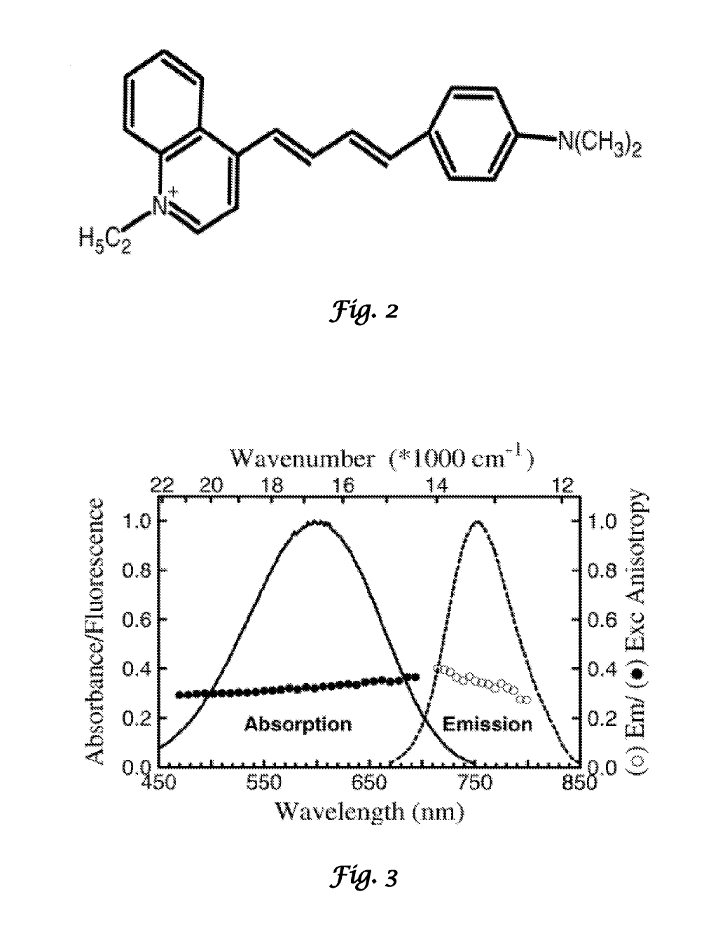

The structure of LDS 798 compound is illustrated in FIG. 2. The structure consists of phenyl and quinoline rings with positive charge delocalized across the quinoline ring and system of five conjugated bonds. This elongated molecule can be efficiently oriented in an anisotropic environment.

Normalized absorption and emission spectra of LDS 798 doped PVA films in the visible range to NIR are shown on FIG. 3. Maximum absorption spectrum was found at about 600 nm. Both absorption and fluorescence spectra are not structured and display a large stock shift. Excitation anisotropy data (FIG. 3 filled circles) at the observation 750 nm reveals that the lowest energy absorption band (electronic S_{O}→S₁ transition) is a single transition oriented almost parallel to the long molecular axis. In fact, anisotropy for whole long wavelength absorption band is high and constant consistent with single transition. Emission spectrum shown in FIG. 3 was recorded using an excitation wavelength of 635 nm. As expected, emission spectrum does not change shape when excited with different wavelengths. Measured fluorescence anisotropy within the emission band slightly decreases for longer wavelength, suggesting a residual relaxation process.

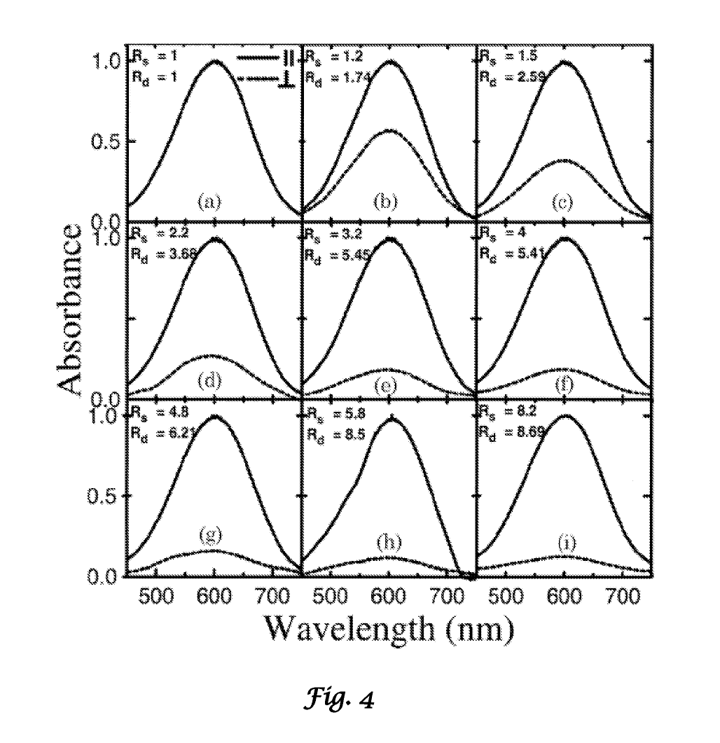

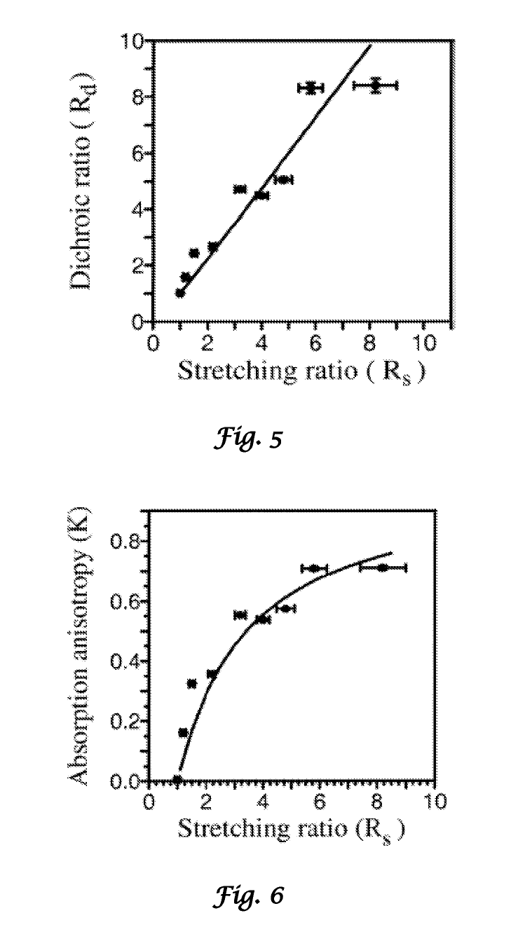

The strong single electronic transition in the wide (visible—NIR) range of wavelengths and the large stock shift make LDS 798 dye a good candidate for the fluorescence standard. The inventors estimated the quantum yield (QY) of LDS 798 in PVA as 0.47 comparing to the ethanol solution of nile blue, QY=0.27 [28]. FIG. 4 presents the polarized absorption spectra of PVA films containing LDS 798 in function of stretching ratio. In general, the spectra show progressive increase of dichroic ratio with increasing of stretching ratio as expected for elongated molecules. Dichroic ratio shown in FIG. 5 progressively increases with film stretching ratio. The dependence of absorption anisotropy versus stretching ratio is shown on FIG. 6.

Based on Eq. 4 an average orientation of absorption transition dipole moment of LDS 798 chromophore with respect to the long axis of this molecule can be calculated. The theoretical fit to experimental data indicates that that angle Φ<0, which means that transition dipole moment for LDS 798 is practically aligned along axis of the molecule.

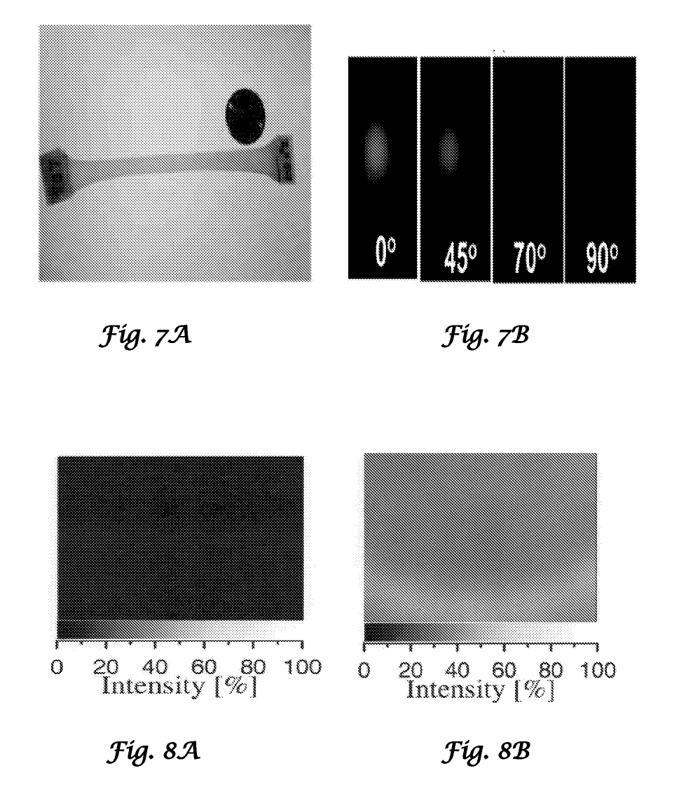

Highly efficient orientation of LDS 798 molecule under stretching conditions can be seen on FIGS. 7A-8B. FIG. 7B shows four photographs of fluorescence spots received from 8.2 stretched polymer film illuminated with visible nonpolarized light and observed through analyzing polarizer with different orientation relative to stretching direction. Different angles give easily recognizable differences in intensity of fluorescence light. FIGS. 8A and 8B present images data measured by with CCD camera in microscope configuration for the same stretched film for 2 orthogonal orientations, perpendicular and orthogonal relative to excitation polarizer orientation, respectively. Almost 80% change in intensity was observed by the system when changing the film orientation.

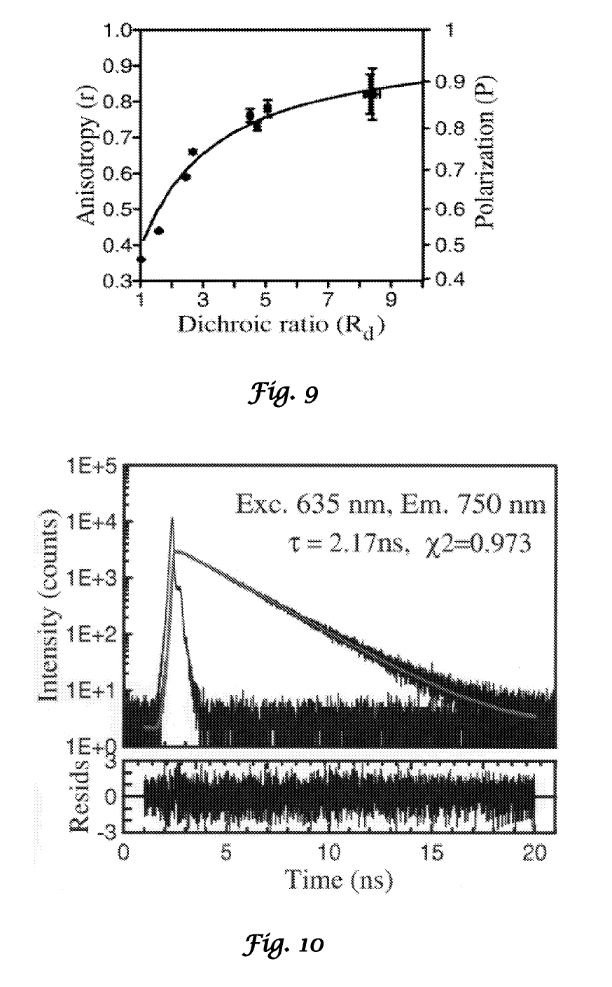

The angular relation between electronic transition dipole moment for absorption and emission is given by Eq. 10 and is reflected in the plot of fluorescence anisotropy in function of dichroic ratio (FIG. 9).

Maximum value of anisotropy (0.82) was observed for 8 times stretching ratio. The solid line in FIG. 9 is a theoretical prediction to experimental values as expected in Eq. 10. Although this equation is only an approximation, very good fit can be observed for the angle between absorption and emission transition dipole moments of about φ=8 deg.

Measured fluorescence intensity decay for this chromophore in the isotropic PVA film is presented in FIG. 10. Data were obtained with excitation pulse at 635 nm and observation at 750 nm. Very good fit with fluorescence decay of the LDS798 was obtained using single exponential (χ² value around 1). Analysis of intensity decay reveals single fluorescence lifetime (2.17 ns) reported also in Table 1. Fluorescence lifetime drops significantly for the same probe in organic solvents and water (data not shown).

TABLE 1
Photophysical characteristics of LDS 798 doped PVA film.

| | λ^{max}_{abs} | λ^{max}ₑₘ | | τ | | φ |
|---|---|---|---|---|---|---|
| Compound | (nm) | (nm) | QY | (ns) | rₘₐₓ | (deg) |
| LDS 798 in PVA film | 600 | 750 | 0.47 | 2.17 | 0.37 | 8 |

LDS798 dye has been characterized in PVA films. The dye has a single electronic transition So-S₁ in red and NIR regions, and displays high degree of linear dichroism and fluorescence anisotropy (FIGS. 3 and 4). This chromophore shows also a good fluorescence quantum yield (0.47). The progressive stretching of the polymeric films is accompanied with a progressive orientation of the dye molecules along the stretching axis. The absorption and fluorescence measurements conducted in a front-face configuration provided the quantitative data on a dichroic ratio, as well as on fluorescence quantum yield, lifetime and anisotropy. The known values of anisotropy can be used to determine the correction factors in polarization measurements with using the microscope. This is important in the case of high numerical aperture objectives which distort polarization [29]. In order to evaluate this distortion, the inventors rotated the unstretched LDS798 doped PVA film and observed fluorescence signals through polarizer oriented parallel or perpendicular to the polarization direction of excitation laser (FIG. 11).

In the case of an isotropic film, polarized components of fluorescence do not depend on the orientation of the sample. The ratio of parallel to perpendicular emission components remains constant at the value of 2.79. If polarized components were not distorted, the ratio should be equal 2.41 which corresponds to the value of anisotropy 0.32 (see FIG. 3 at 635 nm excitation). In order to obtain a correct value of anisotropy, the parallel component should be multiply by the factor 1.16 (G-factor).

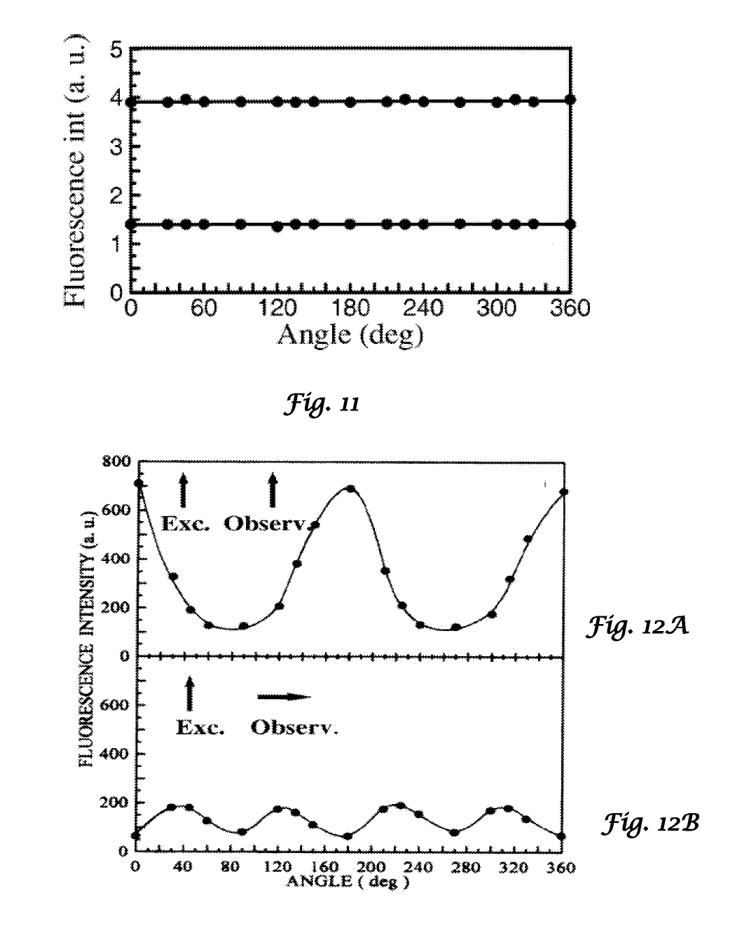

There is another way to find the G-factor with using stretched samples. In this case it is not necessary to know the value of the sample anisotropy, and therefore it is a more general and accurate method. FIGS. 12A and 12B show the polarized components while the stretched sample was rotated on the microscope stage.

Because of the symmetry of the fluorophores distribution in the stretched film, the maximum intensity of perpendicular component appears with double frequency (compare panels A and B on FIG. 12). When the film is oriented and excited at 45 degrees, the parallel and perpendicular components must be equal. The ratio of the intensities of polarized components measured with parallel and perpendicular orientation of analyzer-polarizer is equal to the G-factor value. The same ratio was found for different stretched films and does not depend on the stretching ratio. The average value of the G-factor estimated from stretched and isotropic films was found to be 1.155. This is a very close value to that determined from the unstretched film method. This simple method for finding the G-factor can be used in any spectroscopy/microscopy instrumentation.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof' as used herein refers to all permutations and combinations of the listed items preceding the term. For example, “A, B, C, or combinations thereof' is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

### REFERENCES

U.S. Pat. No. 6,259,524: Photobleachable luminescent layers for calibration and standardization in optical microscopy.

U.S. Pat. No. 7,072,036: Fluorescence reference plate.

U.S. Pat. No. 7,248,356: Calibration aid.

1. U. Resch-Genger, K. Hoffmann, W. Nietfeld, A. Engel, J. Neukammer, R. Nitschke, B. Ebert, and R. Macdonald, “How to improve Quality Assurance in fluorometry: fluorescence inherent sources of error and suited fluorescence standards,” Journal of Fluorescence, 15(3), 337-362 (2005).

2. U. Resch-Genger, K. Hoffmann, and A. Hoffmann, “Standardization of fluorescence measurements criteria for the choice of suitable standards and approaches to fit-for-purpose calibration tools,” Ann. N.Y. Acad. Sci. 1130, 35-43 (2008).

3. A. Periasamy, M. Elangovan, E. Elliott, and D. L. Brautigan, “Fluorescence lifetime imaging (FLIM) of green fluorescent fusion proteins in living cells,” Methods Mol Biol 183, 89-100 (2002).

4. S. Hohng, C. Joo, and T. Ha, “Single-molecule three-color FRET,” Biophys J 87, 1328-1337 (2004).

5. H. Yang, G. Luo, P. Karnchanaphanurach, T. M. Louie, I. Rech, S. Cova, L. Xun, and X. S. Xie, “Protein conformational dynamics probed by single-molecule electron transfer,” Science 302, 262-266 (2003).

6. X. Zhuang, H. Kim, M. J. Pereira, H. P. Babcock, N. G. Walter, and S. Chu, “Correlating structural dynamics and function in single ribozyme molecules,” Science 296, 1473-1476 (2002).

7. I. Koyama-Honda, K. Ritchie, T. Fujiwara, R. lino, H. Murakoshi, R. S. Kasai, and A. Kusumi, “Fluorescence imaging for monitoring the colocalization of two single molecules in living cells,” Biophys J 88, 2126-2136 (2005).

8. P. H. Lommerse, H. P. Spaink, and T. Schmidt, “In vivo plasma membrane organization: results of biophysical approaches,” Biochim Biophys Acta 1664, 119-131 (2004).

9. K. Bacia, I. V. Majoul, and P. Schwille, “Probing the endocytic pathway in live cells using dual-color fluorescence cross-correlation analysis,” Biophys J 83, 1184-1193 (2002).

10. N. Kahya, D. Scherfeld, K. Bacia, B. Poolman, and P. Schwille, “Probing lipid mobility of raft-exhibiting model membranes by fluorescence correlation spectroscopy,” J Biol Chem 278, 28109-28115 (2003).

11. J. R. Lakowicz, “Fluorescence Correlation Spectroscopy” in Principles of Fluorescence Spectroscopy, 797-840 (Springer, 2006).

12. Z. Gryczynski, I. Gryczynski, and J. R. Lakowicz, “Basics of fluorescence and FRET” in Molecular imaging, FRET microscopy and spectroscopy, Periasamy, A. Day, N. R., 21-56 (Oxford, 2005).

13. W. M. Shih, Z. Gryczynski, J. R. Lakowicz, and J. A. Spudich, “A FRET-based sensor reveals large ATP hydrolysis-induced conformational changes and three distinct states of the molecular motor myosin,” Cell 102, 683-694 (2000).

14. A. P. Demchenko, I. Gryczynski, Z. Gryczynski, W. Wiczk, H. Malak, and M. Fishman, “Intramolecular dynamics in the environment of the single tryptophan residue in staphylococcal nuclease,” Biophys Chem 48, 39-48 (1993).

15. Z. Gryczynski, and E. Bucci, “A new front-face optical cell for measuring weak fluorescent emissions with time resolution in the picosecond time scale,” Biophys Chem 48, 31-38 (1993).

16. Z. Gryczynski, E. Bucci, and J. Kusba, “Linear dichroism study of metalloporphyrin transition moments in view of radiationless interactions with tryptophan in hemoproteins,” Photochem Photobiol 58, 492-498 (1993).

17. R. B. Thompson, I. Gryczynski, and J. Malicka, “Fluorescence polarization standards for high-throughput screening and imaging,” Biotechniques 32(1), 34-41 (2002).

18. K. Mandal, T. D. L. Pearson, and J. N. Demas, “Luminescent quantum counters based on organic dyes in polymer matrixes,” Anal. Chem., 52 (13), 2184-2189 (1980).

19. D. Pfeifer, K. Hoffmann, A. Hoffmann, C. Monte, and U. Resch-Genger, “The calibration kit spectral fluorescence standards—A simple and certified tool for the standardization of the spectral characteristics of fluorescence instruments,” J Fluoresc, 16, 581-587 (2006).

20. A. Kawski, and P. Bojarski, “Photoselection of luminescent molecules in isotropic and anisotropic media by multiphoton excitation. Electronic transition moment directions,” Asian Journal of Spectroscopy 11, 67-94 (2007).

21. A. Kawski, and Z. Gryczynski, “On the determination of transition-moment directions from emission anisotropy measurements,” Z Naturforsch 41a, 1195-1199 (1986).

22. A. Kawski, and Z. Gryczynski, “On the determination of transition-moment directions from emission anisotropy measurements,” Z Naturforsch 42a, 617-621 (1987).

23. A. Kawski, and Z. Gryczynski, “Determination of the transition-moment directions from photoselection in partially oriented systems,” Z Naturforsch 42a, 808-812 (1987).

24. A. Kawski, and Z. Gryczynski, “Relation between the emission anisotropy and the dichroic ratio for solute alignment in streached polymer films,” Z Naturforsch 42a, 1396-1398 (1987).

25. C. Horcssler, B. Hardy, and E. Fredericq, “Interaction of ethidium bromide with DNA. Optical and electrooptical study,” Biopolymers 13, 1144-1160 (1974).

26. Y. Matsuoka, “Film dichroism. 4. linear dichroism study of orientation behavior of planar molecules in stretched poly(vinyl alcohol) film,” J Phys Chem 84, 1361-1366 (1980).

27. Y. Tanizaki, “The correction of the relation of the optical density ratio to the stretch ratio to the dichroic spectra,” Bull Chem Soc Japan 38, 1798-1799 (1965).

28. R. Sens, and K. H. Drexhage, “Fluorescence quantum yield of oxazine and carbazine laser dyes,” J Luminesc 24/25, 709-712 (1981).

29. D. Axelrod, “Carbocyanine dye orientation in red cell membrane studied by microscopic fluorescence polarization,” Biophys J 26, 557-573 (1979).

What is claimed is:

1. A microscopy/spectroscopy system calibration standard comprising a polymer film, a liquid crystal or stretched polymer film embedded with one or more dyes, wherein the calibration standard comprises a consistent polarization value and stability.

2. The calibration standard of claim 1, wherein the dye is selected from 7-Amino-actinomycin D, Acridine orange, Acridine yellow, Alexa Fluor, AnaSpec, Auramine O, Auramine-rhodamine stain, Benzanthrone, 9,10-Bis(phenylethynyl)anthracene, 5,12-Bis(phenylethynyl)naphthacene, CFDA-SE, CFSE, Calcein, Carboxyfluorescein, 1-Chloro-9,10-bis(phenylethynyl)anthracene, 2-Chloro-9,10-bis(phenylethynyl)anthracene, Coumarin, Cyanine, DAPI, Dark quencher, Dioc6, DyLight Fluor, Ethidium bromide, Fluorescein, Fura-2, Fura-2-acetoxymethyl ester, Green fluorescent protein, Hilyte Fluor, Hoechst stain, Indian yellow, Luciferin, Perylene, Phycobilin, Phycoerythrin, Phycoerythrobilin, Propidium iodide, Pyranine, Rhodamine, RiboGreen, Rubrene, Ruthenium(II) tris(bathophenanthroline disulfonate), diphenyl polyenes, stilbenes, trans-styrenes, p-terphenyl derivatives, styryl 11, SYBR Green, Stilbene, TSQ, Texas Red, Umbelliferone, and Yellow fluorescent protein.

3. The calibration standard of claim 1, wherein the polymer is selected from polyolefins, polyesters, polyamides, polyurethanes, Poly(vinyl) alcohol, Poly(allylamine), polyethylene, polypropylene, fluoropolymers, PVF, PVDF, PFA, FEP, co-polymers, Acrylic acid, Acrylamide, (Diethylamino)ethyl methacrylate, (Ethylamino)methacrylate, Methacrylic acid, methylmethacrylate, Triazacyclononane-copper(II) complex, 2-(methacryloyxloxy) ethyl phosphate, methacrylamide, 2-(trifluoromethyl)acrylic acid, 3-aminophenylboronic acid, poly(allylamine), o-phthalic dialdehyde, oleyl phenyl hydrogen phosphate, 4-vinylpyridine, vinylimidazole, 2-acryloilamido-2,2′-methopropane sulfonic acid, Silica, organic silanes, N-(4-vinyl)-benzyl iminodiacetic acid, Ni(II)-nitrilotriacetic acid, N-acryloyl-alanine, ethylene glycol dimethacrylate, pentaerythritol triacrylate, pentaerythritol tetraacrylate, trimethylolpropane trimethacrylate, vinyl triethoxysilane, vinyl trimethoxysilane, toluene 2,4-diisocyanate, epichlorohydrin, triglycerolate diacrylate, polystyrene, Propylene glycol dimethacrylate, poly(ethylene glycol) n dimethacrylate, methacrylate derived silica, acrylonitrile, N,N′-dimethylacrylamide, and poly(ethylene glycol)diacrylate.

4. The calibration standard of claim 1, wherein the dyes have an absorption and an emission spectra in an optical UV, a visible or a NIR range.

5. The calibration standard of claim 1, wherein the dyes have an absorption and an emission spectra between about 210 nm and about 900 nm.

6. The calibration standard of claim 1, wherein the dyes have an absorption and an emission spectra of 200 nm, 210 nm, 250 nm, 300 nm, 350 nm, 400 nm, 450 nm, 500 nm, 550 nm, 600 nm, 630 nm, 635 nm, 650 nm, 700 nm, 730 nm, 750 nm, 800 nm, 850 nm, and 900 nm.

7. The calibration standard of claim 1, wherein the polymer film is stretched to a length that is between about 1 and about 10 times its original length.

8. The calibration standard of claim 1, wherein the polymer film is stretched to a length that is 1, 2, 3, 4, 5, 6, 7, 8, 9, and 10 times the polymer length.

9. The calibration standard of claim 1, wherein the polymer film has a thickness between about 5 and about 5000 micrometers.

10. The calibration standard of claim 1, wherein the polymer film has a thickness of 5, 50, 100, 250, 500, 750, 1000, 2000, 2500, 3000, 4000, and 5000 micrometers.

11. The calibration standard of claim 1, wherein the polymer film is partially (axially) oriented.

12. The calibration standard of claim 1, wherein the calibration standard is used as a standard in a fluorescence polarization technique for the detection of a nonmelanoma skin cancer, diagnosis of a colon cancer, assessment of a fetal lung maturity, and a high throughput screening assays or for drug development.

13. The calibration standard of claim 1, further comprising a plastic or laminate on or about the stretched polymer film.

14. A method of preparing a calibration standard comprising a stretched dyed-embedded polymer film comprising the steps of:
embedding a dye by mixing the stretchable polymer solution with a solution of a dye to form a dye-embedded polymer solution;
drying the dye-embedded polymer solution to form a dye-embedded polymer film;
stretching the dye-embedded polymer film to obtain the stretched dye-embedded polymer film; and
measuring an absorption, emission, and excitation spectra of the stretched dye-embedded polymer film, wherein the stretched dye-embedded polymer film provides a known dichroic ratio, a fluorescence quantum yield, a lifetime and an anisotropy.

15. The method of claim 14, wherein the step of embedding the dye in the stretchable polymer can alternatively be accomplished by crushing the dye and mixing it with the one or more stretchable polymer flakes to form a mixture, a blend or a mold followed by extruding the mixture, the blend or the mold.

16. The method of claim 14, wherein the step of embedding a dye in the stretchable polymer can alternatively be accomplished by mixing or dissolving the dye in a polymer melt and allowing the mixture or solution to cool to form a film.

17. The method of claim 14, wherein the step of embedding a dye in the stretchable polymer can alternatively be accomplished by mixing or dissolving the dye and polymer in a solvent and then removing the solvent.

18. The method of claim 14, wherein a fluorescence signal, a polarization signal or both of the dye in the stretched dye-embedded polymer film is measured in a square or a front-face configuration, an in-line configuration, a combination of one or all the configurations.

19. The method of claim 14, wherein the dye is selected from 7-Amino-actinomycin D, Acridine orange, Acridine yellow, Alexa Fluor, AnaSpec, Auramine O, Auramine-rhodamine stain, Benzanthrone, 9,10-Bis(phenylethynyl)anthracene, 5,12-Bis(phenylethynyl)naphthacene, CFDA-SE, CFSE, Calcein, Carboxyfluorescein, 1-Chloro-9,10-bis(phenylethynyl)anthracene, 2-Chloro-9,10-bis(phenylethynyl)anthracene, Coumarin, Cyanine, DAPI, Dark quencher, Dioc6, DyLight Fluor, Ethidium bromide, Fluorescein, Fura-2, Fura-2-acetoxymethyl ester, Green fluorescent protein, Hilyte Fluor, Hoechst stain, Indian yellow, Luciferin, Perylene, Phycobilin, Phycoerythrin, Phycoerythrobilin, Propidium iodide, Pyranine, Rhodamine, RiboGreen, Rubrene, Ruthenium(II) tris(bathophenanthroline disulfonate), diphenyl polyenes, stilbenes, trans-styrenes, p-terphenyl derivatives, styryl 11, SYBR Green, Stilbene, TSQ, Texas Red, Umbelliferone, and Yellow fluorescent protein.

20. The method of claim 14, wherein the polymer is selected from polyolefins, polyesters, polyamides, polyurethanes, Poly(vinyl) alcohol, Poly(allylamine), polyethylene, polypropylene, fluoropolymers, PVF, PVDF, PFA, FEP, co-polymers, Acrylic acid, Acrylamide, (Diethylamino)ethyl methacrylate, (Ethylamino)methacrylate, Methacrylic acid, methylmethacrylate, Triazacyclononane-copper(II) complex, 2-(methacryloyxloxy) ethyl phosphate, methacrylamide, 2-(trifluoromethyl)acrylic acid, 3-aminophenylboronic acid, poly(allylamine), o-phthalic dialdehyde, oleyl phenyl hydrogen phosphate, 4-vinylpyridine, vinylimidazole, 2-acryloilamido-2,2′-methopropane sulfonic acid, Silica, organic silanes, N-(4-vinyl)-benzyl iminodiacetic acid, Ni(II)-nitrilotriacetic acid, N-acryloyl-alanine, ethylene glycol dimethacrylate, pentaerythritol triacrylate, pentaerythritol tetraacrylate, trimethylolpropane trimethacrylate, vinyl triethoxysilane, vinyl trimethoxysilane, toluene 2,4-diisocyanate, epichlorohydrin, triglycerolate diacrylate, polystyrene, Propylene glycol dimethacrylate, poly(ethylene glycol) n dimethacrylate, methacrylate derived silica, acrylonitrile, N,N′-dimethylacrylamide, and poly(ethylene glycol)diacrylate.

21. The method of claim 14, wherein the dyees have an absorption and emission spectra between about 210 nm to about 900 nm.

22. The method of claim 14, wherein the dye has an absorption and an emission spectra of 200 nm, 210 nm, 250 nm, 300 nm, 350 nm, 400 nm, 450 nm, 500 nm, 550 nm, 600 nm, 630 nm, 635 nm, 650 nm, 700 nm, 730 nm, 750 nm, 800 nm, 850 nm, and 900 nm.

23. The method of claim 14, wherein the polymer film is stretched to a length that is between about 1 to about 10 times the polymer length.

24. The method of claim 14, wherein the polymer film is stretched 1, 2, 3, 4, 5, 6, 7, 8, 9, and 10 times the polymer length.

25. The method of claim 14, wherein the polymer film has a thickness between about 5 and about 5000 micrometers.

26. The method of claim 14, wherein the polymer film has a thickness of 5, 50, 100, 250, 500, 750, 1000, 2000, 2500, 3000, 4000, and 5000 micrometers.

27. The method of claim 14, wherein the polymer film is partially (axially) oriented.

28. The method of claim 14, further comprising a plastic or laminate on or about the stretched polymer film.

29. A method of calibrating a microscopy system or a spectroscopy system comprising the steps of: placing a calibration standard comprising a stretched polymer film embedded with a flurophore-containing dye in or on the microscopy or the spectroscopy system, wherein the dye has an absorption and an emission spectra in an optical UV, a visible, or a NIR range;
stretching the polymer film in a direction parallel or perpendicular to the direction of a polarized light emanating from a polarizer of the microscopy or the spectroscopy system;
illuminating the stretched polymer film with a visible non-polarized light;
observing the light from an analyzer of the microscopy or the spectroscopy system, wherein the analyzer is oriented in a direction that is different from the direction of the stretched polymer film; and
calibrating the microscopy or spectroscopy system by the measuring and quantifying one or more parameters selected from dichroic ratio, fluorescence quantum yield, lifetime, and anisotropy.

30. The method of claim 29, further comprising the step of calculating a G factor.

31. The method of claim 29, wherein the stretched polymer film is a PVA film.

32. The method of claim 29, wherein the dye is a styryl derivative.

33. The method of claim 29, wherein a polarization or a fluorescence polarization of the calibration standard is known a priori.

34. A method of calibrating a microscopy system or a spectroscopy system by a determination of a G factor value using a calibration standard, wherein an anisotropy of the calibration standard is not known a priori, comprising the steps of:
placing the calibration standard, comprising a stretched polymer film embedded with a flurophore-containing dye, in or on the microscopy or the spectroscopy system, wherein the dye has an absorption and an emission spectra in an optical UV, a visible, or a NIR range;
stretching the polymer film first in a parallel orientation followed by stretching the polymer film in a perpendicular orientation, wherein these orientations are performed relative to the direction of a polarized light emanating from a polarizer of the microscopy or the spectroscopy system;
exciting the stretched polymer film by illumination with a visible non-polarized light at a 45° angle;
observing the light from an analyzer of the microscopy or the spectroscopy system, wherein the analyzer is oriented in a direction that is different from the direction of the stretched polymer film;
measuring a light intensity through the film at the parallel orientation and the perpendicular orientation; and
determining a ratio of the intensities of measured with both the parallel and perpendicular orientations, wherein the ratio is equal to the G factor value.

35. The method of claim 34, wherein a polarization or a fluorescence polarization of the calibration standard is not known a priori.

36. The method of claim 34, wherein the stretched polymer film is a PVA film.

37. The method of claim 34, wherein the dye is a styryl derivative.
